(19) United States
(12) Patent Application Publication
(10) Pub. No.: US 2026/0308952 A1
(43) Pub. Date: Oct. 8, 2026

(54) MOTOR VEHICLE LOCK

(71) Applicant: Kiekert Aktiengesellschaft, Heiligenhaus (DE)

(72) Inventors: Michael SCHOLZ, Essen (DE); Holger SCHIFFER, Meerbusch (DE); Ömer INAN, Dorsten (DE); Peter SZEGENY, Engelskirchen (DE)

(73) Assignee: Kiekert Aktiengesellschaft, Heiligenhaus (DE)

(21) Appl. No.: 19/487,036

(22) PCT Filed: Mar. 13, 2024
(86) PCT No.: PCT/DE2024/100200

§ 371 Date: Nov. 24, 2025

(30) Foreign Application Priority Data
Apr. 21, 2023 (DE) 10 2023 110 265.6

(51) Int. Cl. E05B 81/14; E05B 81/06; E05B 81/30; E05B 81/34

(52) U.S. Cl. CPC E05B 81/14; E05B 81/06; E05B 81/30; E05B 81/34

(57) ABSTRACT

A motor vehicle lock, in particular a motor vehicle door lock, which is provided with a locking mechanism substantially consisting of a rotary latch and a pawl. Additionally, a mechanical actuating lever chain provided, as is an electric motor drive The locking mechanism can be opened by means of the electric motor drive and the actuating lever chain. In addition, the actuating lever chain and the electric motor drive are connected to one another via a coupling element. According to the invention, the actuating lever chain removes the coupling element from the drive when said actuating lever chain is acted upon, and when there is at least a reversing of the drive.

### DESCRIPTION

The invention relates to a motor vehicle lock, in particular a motor vehicle door lock, with a locking mechanism consisting substantially of a rotary latch and a pawl, furthermore with a mechanical actuating lever chain, and with an electromotive drive, wherein the locking mechanism can be opened by means of the electromotive drive and the actuating lever chain, and wherein the actuating lever chain and the drive are connected to one another via a coupling element.

The claimed motor vehicle lock is basically any locking device in or on a motor vehicle. These include not only the motor vehicle door locks mentioned in particular, but also motor vehicle tailgate locks, motor vehicle hood locks, motor vehicle tank and tailgate locks, locks for glove compartments or seats, etc. Nowadays, such vehicle locks are typically opened using an electric motor. For this purpose, the electric motor drive usually operates on a release lever.

The release lever can then be used to lift a pawl from its latching engagement with the rotary latch when the locking mechanism is closed. As a result, the rotary latch opens in a spring-assisted manner and releases a previously caught locking bolt. The associated motor vehicle door can be opened. Such electromotive drives for the electric opening of vehicle locks are particularly convenient and can be operated with virtually no effort on the part of the user.

For this purpose, it is conceivable, for example, that the user in question operates an outside door handle that is equipped with a sensor. The sensor query via a control unit then provides information about the actuation of the door handle and initiates the electrical opening operation for the locking mechanism. In principle, this electrical opening operation can also be initiated automatically in connection with a question/answer dialog. In this case, the user has a transponder that is queried by the associated vehicle to determine whether the user is authorized for access. The positive query then triggers the electrical opening of the locking mechanism (“keyless entry”).

As the aforementioned electric motor drive is typically supplied with electrical energy from an energy source in the vehicle, such as a vehicle battery, the lock cannot (or can no longer) be opened electrically if the vehicle battery fails. Such a failure of the vehicle battery is conceivable, for example, as a result of aging or after long periods of inactivity. The same applies if the motor vehicle is involved in an accident.

For this reason, such motor vehicle locks are usually also equipped with so-called mechanical redundancy. This is represented using the mechanical actuating lever chain. The design is usually such that the mechanical actuating lever chain is generally open with a current-loaded electric motor drive, so that the lock is not additionally loaded via the mechanical actuating lever chain. Usually, the mechanical actuating lever chain and the electric motor drive jointly use the previously mentioned release lever to lift the locking mechanism.

In order for the electric motor drive on the one hand and, for example, a door handle as part of the mechanical actuating lever chain on the other hand to be able to work at least alternatively on the release lever in question to open the locking mechanism, the actuating lever chain and the drive are generally mechanically connected to one another via the coupling element. In principle, this also makes it possible to reset the electric motor drive using the mechanical actuating lever chain if the electric motor drive fails.

In the generic prior art according to DE 10 2019 133 654A1 , the release lever there can be actuated by means of the electric motor drive and at least one manually operable actuating lever as part of the actuating lever chain. A locking unit is also provided, which can be used to prevent the locking mechanism from being unlocked manually.

The state of the art has proven itself in principle, but there is still room for improvement. In practice, the coupling element connecting the electric motor drive to the actuating lever chain is often used to move the coupling element in question both when the locking mechanism is opened electrically and when the electric motor drive returns. This allows the actuating lever chain to be selectively opened or closed, for example, via the coupling element and the connected actuating lever chain. Actuating the electric motor drive to open the locking mechanism usually results in the actuating lever chain being opened via the coupling element. When the drive is reversed, the actuating lever chain is closed again.

However, due to the entrainment of the coupling element during the movement of the electric motor drive, there is a risk, particularly during a reversing movement of the electric motor drive, that the coupling element, which is moved back as it were, and the actuating lever chain will practically work against one another if the actuating lever chain is also acted upon by the door handle during this operation. This can lead to blockages or at least to a manual actuation of the operating lever chain that is difficult to apply and thus to haptic losses. From a comfort perspective, this is considered a disadvantage by operators. The invention as a whole seeks to remedy this.

The invention is based on the technical problem of further developing such a motor vehicle lock and, in particular, a motor vehicle door lock in such a manner that perfect functionality with a simple design and, in particular, improved haptics compared to the prior art are observed.

To solve this technical problem, a generic motor vehicle lock within the scope of the invention is characterized in that the actuating lever chain is removed from the drive and in particular swivels away when it is actuated and at least one reversing of the drive.

The invention is based first of all on the realization that the coupling element is generally pivotably mounted in an associated lock housing. The coupling element interacts on the one hand with the electric motor drive and on the other hand with the actuating lever chain. For this purpose, the coupling element is generally equipped with a control arm which interacts or can interact with a control element as part of the electric motor drive. For this purpose, the electric motor drive generally has an electric motor and the aforementioned control element. The control element can advantageously be a worm wheel.

In addition, the coupling element is usually equipped with an actuating arm, which is mechanically connected to the actuating lever chain. Thus, as soon as the control element performs movements initiated by the electric motor, these not only lead to the locking mechanism being opened electrically in accordance with the invention. This is generally accompanied by a swivel movement of the coupling element, which is transmitted to the actuating lever chain via the actuating arm. This allows the actuating lever chain to be transferred to different functional positions during the described electrical opening process of the locking mechanism, for example from its open state to the closed state and back, or vice versa. For this purpose, the coupling element generally works on a coupling lever as part of the actuating lever chain, which is engaged or disengaged accordingly.

When the coupling lever is “engaged”, the actuating lever chain is mechanically closed at the same time. In contrast, the “disengaged” state of the coupling element corresponds to the actuating lever chain being mechanically open. As already mentioned, these different functional positions can be realized simultaneously with the electrical opening of the locking mechanism according to the invention or can be approached when reversing the electromotive drive.

To prevent any collisions with the actuating lever chain, at least during the reversing of the electromotive drive in question, or the actuating lever chain and the reversing electromotive drive working in opposite directions on the coupling element, the actuating lever chain ensures that the coupling element is removed or swung away from the drive when it is actuated. As a result of this, the control element or worm wheel as a component of the electric motor drive performs a freewheel in relation to the actuating lever chain.

This prevents any collisions between the coupling element and the actuating lever chain on the one hand. On the other hand, the haptics are also improved because, particularly when reversing the electromotive drive, additional actuation of the actuating lever chain is now possible because the coupling element is pivoted away in relation to the reversing control element, meaning that in this case it is “only” actuated by the actuating lever chain and not additionally by the control element as part of the electromotive drive. This also improves the overall haptics.

At the same time, the invention ensures that the coupling element can interact with the electric motor drive again after the actuating lever chain is no longer actuated. This means that the actuation of the actuating lever chain first of all ensures freewheeling of the control element as part of the electric motor drive. However, if the actuating lever chain is no longer actuated, the freewheel also ends and the coupling element interacts again with the electric motor drive or can interact with it. This is particularly advantageous if certain functional positions of the actuating lever chain can be realized and implemented at the same time when the electric motor drive is actuated to open the locking mechanism electrically. In contrast, such a functional sequence is often not required when reversing the electromotive drive on the actuating lever chain.

Either way, the temporary freewheeling of the control element and in particular the worm wheel, which is initiated by the operating lever chain or a door handle, ensures that any functional impairments are avoided on the one hand and that the haptics are improved on the other. Because opposing braking movements are expressly avoided within the scope of the invention. These are the main advantages.

In a further advantageous embodiment, the actuating lever chain also has a coupling lever in addition to a release lever, an actuating lever and the aforementioned door handle. In accordance with the invention, the coupling lever is equipped with a contour which is designed to interact with a counter contour on the coupling element. The interaction between the contour and the counter contour ensures that the desired freewheel is achieved when the actuating lever chain and thus the coupling lever are actuated, or that the contour on the coupling lever moves against the mating contour on the coupling element and in this manner the coupling element pivots away from its engagement with the control element as part of the electromotive drive.

Alternatively or in addition to this exemplary contour on the coupling lever as a component of the actuating lever chain, a supplementary freewheel lever can also be realized as a component of the actuating lever chain. This freewheel lever is set up to interact with the coupling element and, when the actuating lever chain is actuated and at least when the electric motor drive is reversed, ensures that the control element can perform the desired freewheel as part of the electric motor drive. For this purpose, the freewheel lever works on the coupling element and generally swivels it away from its engagement with the control element or worm wheel.

Furthermore, the design can be such that the coupling element has a coupling element. The coupling element is typically preloaded by means of a spring in the direction of the drive and specifically in the direction of the control element or worm wheel as part of the electric motor drive. The spring can be connected to the coupling element.

In a first variant, the coupling element is mounted on the coupling element so that it can be moved linearly. As soon as the actuating lever chain or the door handle as part of the actuating lever chain is actuated and the electric motor drive reverses at the same time, the linearly displaceable coupling element is pushed back by the control element or worm wheel against the force of the spring. As soon as the reversing movement is complete, the linearly displaceable coupling element can once again interact with the control element or worm wheel.

As an additional or alternative option, it is also conceivable that the coupling element is rotatably mounted on the coupling element. In this case, the coupling element is advantageously equipped with an actuating pin, which is typically located on the head side of the coupling element and on the control arm. The coupling element can interact with the control element or worm wheel via the actuating pin in question. The worm wheel may be equipped with a corresponding contour for this purpose.

At the same time, the previously discussed freewheel can now be achieved via this actuating pin. This is because the actuating pin can be moved from an engaged position with the control element or worm wheel to a freewheeling position in relation to the electric motor drive using the coupling element, which is rotatably mounted on the coupling element. This can also be done again against spring force, so that when the rotatable coupling element is no longer actuated, the actuating pin in question is automatically transferred to its engagement position in relation to the control element or worm wheel.

This means that the electric motor drive is advantageously equipped with the electric motor and the control element and, in particular, the worm wheel. The coupling element can then interact with the control element or worm wheel. For this purpose, the worm wheel has at least one contour that acts on the coupling element.

The result is a motor vehicle lock that is functionally reliable and has improved haptics compared to the prior art. This is because the electric motor drive for electrically opening the lock on the one hand and the actuating lever chain on the other hand do not collide with one another to actuate the locking mechanism. Rather, such a collision is ensured by a freewheel of the electric motor drive in relation to the mechanical actuating lever chain. These are the main advantages.

In the following, the invention is explained in more detail with the aid of a drawing showing only an exemplary embodiment; in the figures:

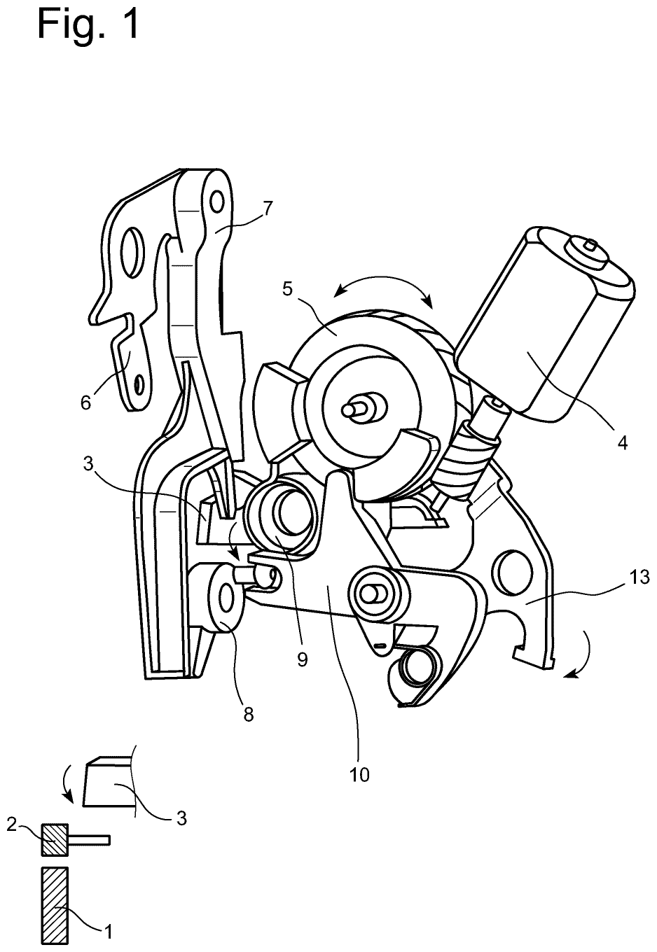

FIG. 1 is a schematic overview of the motor vehicle lock according to the invention in the form of a motor vehicle door lock, and

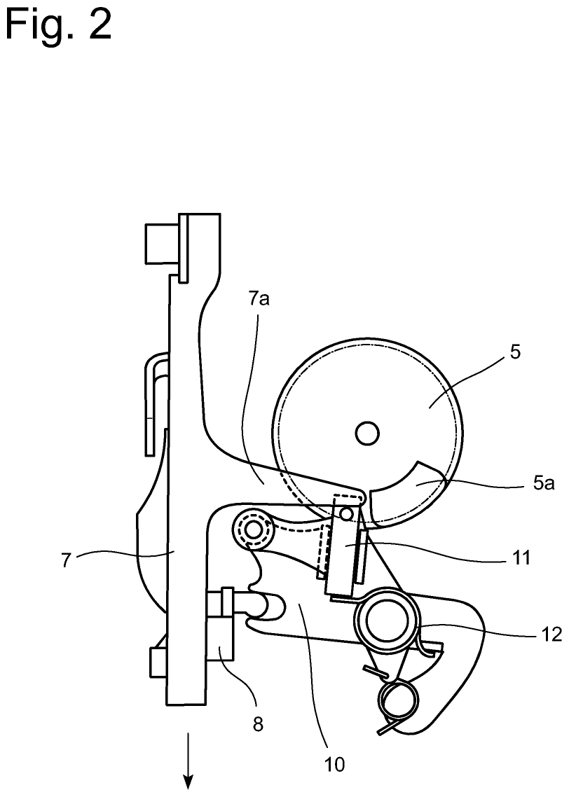

FIG. 2+3 are individual views of the vehicle door lock according to FIG. 1 in different variants.

In the drawings, a motor vehicle lock is shown, which is a motor vehicle door lock. In its basic design, this has a locking mechanism 1, 2, which is only indicated in FIG. 1 and consists substantially of a rotary latch 1 and a pawl 2. In this case, the locking mechanism 1, 2 extends in a plane perpendicular to the drawing plane. To open the locking mechanism, a release lever 3 is provided, which performs a counter-clockwise swivel movement around its axis as shown in FIG. 1. This allows the release lever 3 to move against a pin of the pawl 2 and lift it from its latching engagement with the rotary latch 1 when the locking mechanism 1, 2 is closed. As a result, a locking bolt that is not shown is released and the associated vehicle door can be opened.

An electric motor drive 4, 5 is provided to initiate the swivel movement of the release lever 3 described above for electrically opening the locking mechanism 1, 2. This consists of an electric motor 4 and a control element 5. According to the embodiment example, the control element 5 is a worm wheel which, on its rear side not shown in FIG. 1, is equipped with an actuating cam which, when the control element or worm wheel 5 is pivoted in the indicated counterclockwise direction, pivots the release lever 3 about its axis in the counterclockwise direction shown in FIG. 1.

Additionally, a mechanical actuating lever chain 3, 6, 7, 8, 9, 13 is implemented. The mechanical actuating lever chain 3, 6, 7, 8, 9, 13 has, in addition to the aforementioned release lever 3 interacting with the electric motor drive 4, 5, a door handle or actuating lever 6 or internal actuating lever 6, a coupling lever 7, a deflection lever 8 and one or two transmission levers 9 as well as an actuating lever 13. With the aid of the transmission lever 9, the locking mechanism 1, 2 can be opened as an alternative to the electric motor drive 4, 5 when the actuating lever chain 3, 6, 7, 8, 9, 13 is actuated via the door handle or internal actuating lever 6. To prevent mutual interference or collisions from occurring at this point when the common release lever 3 is actuated, a coupling element 10 is also provided. According to the embodiment example, the coupling element 10 is designed as a reversing lever.

Actually, the coupling element 10 acted upon by the electromotive drive 4, 5 or its worm wheel 5 when the locking mechanism 1, 2 is opened electrically by the electromotive drive 4, 5 generally ensures that the mechanical actuating lever chain 3, 6, 7, 8, 9, 13 is opened in this case. To do this, the coupling lever 7 is disengaged. In the basic position not shown here, however, the coupling lever 7 is engaged and the actuating lever chain 3, 6, 7, 8, 9, 13 is closed. Either way, the actuating lever chain 3, 6, 7, 8, 9, 13 and the electromechanical drive 4, 5 are connected to each other via the coupling element 10.

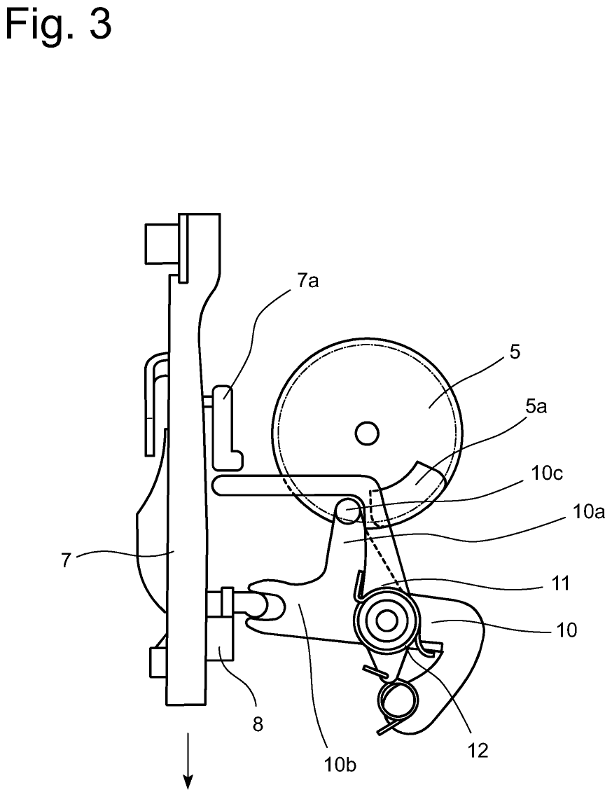

In order to avoid any malfunctions and, in particular, to exclude counter-rotating movements when reversing the electric motor drive 4, 5 after an electrical opening process of the locking mechanism 1, 2 and simultaneously actuated door handle 6, the actuating lever chain 3, 6, 7, 8, 9, 13 ensures that the coupling element 10 is removed from the electric motor drive 4, 5 when it is actuated, in particular with the aid of the door handle 6, and at least when reversing the electric motor drive 4, 5. To this end, the invention proposes two basic variants, which are shown in FIGS. 2 and 3.

In fact, in both FIGS. 2 and 3 one can substantially recognize the control element or worm wheel 5 as a component of the electromotive drive 4, 5 together with the coupling element 10 and a section of the actuating lever chain 3, 6, 7, 8, 9, 13. This section only shows the coupling lever 7 together with the deflection lever 8. In this context, the coupling lever 7 in particular is modified compared to the illustration in FIG. 1.

The variant shown in FIG. 2 is now designed in such a manner that the coupling lever 7 is equipped with a contour or lever arm 7a, which is set up to interact with a counter contour 11 on the coupling element 10. In the design example shown, the counter contour 11 is provided on a coupling element 11 or coincides with it. For this purpose, the coupling element 11 is mounted so as to be linearly displaceable on or in the coupling element 10. FIG. 2 also shows a spring 12, which acts on the coupling element 11 in the direction of the control element 5.

If the operating lever chain 3, 6, 7, 8, 9, 13 is now actuated, for example by an operator pulling on the door handle 6, this generally corresponds to a downward movement of the coupling lever 7, which is indicated by a corresponding arrow in FIG. 2. This downward movement of the coupling lever 7 causes the contour 7a to act on the coupling element 11, i.e. it also moves “downwards” against the force of the spring 12. As a result, the coupling element 11 cannot (or can no longer) interact with the control element or worm wheel 5. This is because an actuating contour 5a provided on the worm wheel 5 runs past the coupling element 11 in this case and is therefore not able to swivel the coupling element 10 counterclockwise around its axis, as is usually the case.

If, on the other hand, the actuating lever chain 3, 6, 7, 8, 9, 13 is no longer actuated, the coupling lever 7 moves upwards and the coupling element 11 can interact with the control element or worm wheel 5 again. In this case, contour 5a on the control element or worm wheel is able to act on coupling element 10 via coupling element 11 and, according to the embodiment, pivot it counterclockwise about its axis. Such a counterclockwise rotation of the coupling element 10 generally results in the actuating lever chain 3, 6, 7, 8, 9, 13 being closed. To do this, the coupling lever 7 is “engaged”.

It can be seen that the spring 12 acting on the coupling element 11 is connected to the coupling element 10 according to the exemplary embodiment. In fact, spring 12 is a double-leg spring, one leg of which is firmly connected to coupling element 10, while the other free leg acts on coupling element 11 in the direction of the control element or worm wheel 5.

In another variant shown in FIG. 3, the coupling element 11 is not mounted on the coupling element 10 in a linearly displaceable manner, but rather in a rotatable manner. In this case, the rotatable coupling element 11 on the one hand and the coupling element 10 on the other use a common axis or axis of rotation, i.e. they are mounted on the same axis.

Furthermore, in this case the coupling element 10 is equipped with an actuating pin 10c. The actuating pin 10c is located on a control arm 10a of the coupling element 10, on the head side. In addition to the control arm 10a, the coupling element 10 is also equipped with an actuating arm 10b, which provides the mechanical connection to the actuating lever chain 3, 6, 7, 8, 9, 13 and specifically to the deflection lever 8 there.

If the actuating lever chain 3, 6, 7, 8, 9, 13 is now acted upon again via the door handle 6 and the coupling lever 7 thus undergoes a “downward” movement as shown in FIG. 3, this causes the coupling element 11 to pivot counterclockwise about the axis common to the coupling element 10 via the corresponding contour 7a, which entrains the rotatable coupling element 11. As a result of this, the rotatable coupling element 11 ensures that the coupling element 10 is also pivoted counterclockwise about the same axis in practically the same phase as the coupling element 11 via the actuating pin 10c on the coupling element 10.

This prevents the actuating pin 10c from interacting with the control element or worm wheel 5 as part of the electric motor drive 4, 5. This means that the coupling element 10 or its actuating pin 10c in this case ensures that the coupling element 10 is transferred from an engaged position to a freewheeling position in relation to the electric motor drive 4, 5 with its help. In the freewheeling position, the control element or worm wheel 5 can therefore rotate freely and, in particular, reverse from the electrical opening process of the locking mechanism 1, 2 to the home position.

Both variants are characterized in that the coupling element 10 can interact with the control element 5 or worm wheel as a component of the electric motor drive 4, 5. In addition, the specific design ensures that when the actuating lever chain 3, 6, 7, 8, 9, 13 is actuated and the electric motor drive 4, 5 is reversed, the control element or worm wheel 5 in particular is released from the coupling element 10 for as long as the mechanical actuating lever chain 3, 6, 7, 8, 9, 13 is actuated.

After the actuating lever chain 3, 6, 7, 8, 9, 13 is no longer actuated, the coupling element 10 can interact with the electric motor drive 4, 5 again. This is because, according to the two embodiment variants in FIGS. 2 and 3, the coupling element 11 is then reset in each case with the aid of the spring 12, so that the contour 5a on the control element or the worm wheel 5 can work on the coupling element 10 and swivel it counterclockwise via the electric motor drive 4, 5.

### LIST OF REFERENCE SIGNS

1 rotary latch
2 pawl
3 release lever
4 electric motor
5 control element
6 internal actuating lever
7 coupling lever
8 deflection lever
9 transmission lever
10 coupling element
10a control arm
10b actuating arm
10c actuating pin
11 counter contour
12 spring
13 actuating lever

1. A motor vehicle lock, in particular a motor vehicle door lock, with a locking mechanism consisting substantially of a rotary latch and a pawl, further with a mechanical actuating lever chain, and with an electromotive drive, wherein the latch can be opened by means of the electromotive drive and the actuating lever chain, and wherein the actuating lever chain and the drive are connected to one another via a coupling element,
wherein
the actuating lever chain removes the coupling element from the drive when it is actuated and at least when the drive is reversed.

2. The motor vehicle lock according to claim 1, wherein the coupling element can interact again with the electric motor drive after the actuating lever chain has ceased to be actuated.

3. The motor vehicle lock according to claim 1, wherein the actuating lever chain is equipped, in addition to a release lever and an actuating lever, in particular an internal actuating lever, with a coupling lever with a contour which is designed to interact with a counter contour on the coupling element.

4. The motor vehicle lock according to claim 1, wherein the actuating lever chain has a freewheel lever for interaction with the coupling element.

5. The motor vehicle lock according to claim 1, wherein the coupling element has a coupling element as a counter contour, which is advantageously pretensioned in the drive by means of a spring.

6. The motor vehicle lock according to claim 5, wherein the spring is connected to the coupling element.

7. The motor vehicle lock according to claim 5, wherein the coupling element is mounted linearly displaceably and/or rotatably on the coupling element,

8. The motor vehicle lock according to claim 7, wherein the coupling element has an actuating pin which, with the aid of the coupling element, can be moved from its engaged position into a freewheeling position relative to the electric motor drive.

9. The motor vehicle lock according to claim 1, wherein the electromotive drive has an electric motor and a control element, in particular a worm wheel.

10. The motor vehicle lock according to claim 9, wherein the coupling element interacts with the control element.
